(19) United States
(12) Patent Application Publication
(10) Pub. No.: US 2009/0166529 A1
(43) Pub. Date: Jul. 2, 2009

(54) METHOD FOR PREPARING SPECIMEN FOR MASS SPECTROMETRY

(76) Inventors: Shuichi Shinma, Okazaki-shi (JP); Mitsutoshi Setou, Okazaki-shi (JP); Yuki Sugiura, Yukohama-shi (JP); Masaru Furuta, Kyoto-shi (JP); Takahiro Harada, Kyoto-shi (JP)

Correspondence Address: GARY C. COHN, PLLC, P. O. Box 313, Huntingdon Valley, PA, 19006, US

(21) Appl. No.: 12/297,160

(22) PCT Filed: Mar. 23, 2007
(86) PCT No.: PCT/JP2007/055949

§ 371 Date: Oct. 14, 2008

Related U.S. Application Data
(60) Provisional application No. 60/792,055, filed on Apr. 14, 2006.

(30) Foreign Application Priority Data
Jun. 7, 2006 (JP) 2006-158597

(51) Int. Cl. B01D 59/44; G01N 1/30; G01N 1/00

(52) U.S. Cl. 250/282; 435/40.52; 436/174

(57) ABSTRACT

The present invention provides a specimen preparation method for mass spectrometry based on Matrix Assisted Laser Desorption Ionization (MALDI), wherein the method enables to form microcrystals (cocrystals) between matrices and biological molecules (protein and the like) on a biological tissue to generate ions thereof highly efficiently and to perform highly sensitive measurement. Microcrystals are formed on the specimen containing biological molecules, i.e. objects of the measurement, by spraying matrix solution beforehand. Furthermore, dispensation of matrix solution on the microcrystals allows crystals to grow by making preformed micro-matrix crystals as crystal nuclei. Therefore, much finer and more homogeneous crystals (cocrystals) are prepared to enable to perform highly sensitive mass spectrometry based on MALDI. The present invention is a specimen preparation method for mass spectrometry based on matrix assisted laser desorption ionization, wherein the method comprises steps forming microcrystals of matrices on the specimen by spraying matrix solution on the specimen and allowing the microcrystals to grow further by dispensing matrix solutions to the specimen.

### FIELD OF THE INVENTION

The present invention relates to a method for preparing a specimen to analyze biological molecules, such as proteins, by mass spectrometry based on Matrix Assisted Laser Desorption Ionization (hereinafter referred to as MALDI), more specifically, to a method for preparing a specimen for mass spectrometry by the use of MALDI to perform mass spectrometry of biological tissues with a high degree of accuracy and a method for mass spectrometry by the use of specimens thus prepared.

### PRIOR ART

In mass spectrometry of biological molecules such as proteins, Matrix Assisted Laser Desorption Ionization method (MALDI) or Electro-spray Ionization method (ESI) is generally used for ionization of specimens. Above all, MALDI is used as direct ionization method for biological tissues for mass spectrometry (Patent reference 1 etc.). A conventional method for ionizing biological tissues directly involves steps comprising washing biological tissues by 70 to 80% aqueous ethanol, drying the tissues and dispensing or spraying matrix (sinapic acid or α-CHCA etc.) directly to the surface of the tissues (Non-patent reference 1 etc.).

These matrices form co-crystal with biological molecules such as protein specimens. Laser irradiation on the co-crystals ionizes the biological molecules. It has been known that the ionization efficiency depends on the size of the co-crystals between matrices and specimens (Non-patent reference 2).

Therefore, various methods have been proposed for preparing microcrystals of matrices on a specimen for mass spectrometry based on MALDI (Patent references 1-3). Recently, a report is published on a method, wherein the method comprises dispensing matrix microcrystals grinded beforehand to the surface of a tissue by a brush, and then dispensing liquid matrix allowing crystals to grow and subjecting the specimen to MALDI based mass spectrometry (Non-patent reference 3).
Patent reference 1: Japanese Patent Application Public Disclosure No. 2005-283123
Patent reference 2: Japanese Patent Application Public Disclosure No. 2003-98154
Patent reference 3: Japanese Patent No. 2569570
Non-patent reference 1: Anal. Chem. 2004, 76, 87A-93A
Non-patent reference 2: Appl. Surf. Sci. 1998, 129, 226-234
Non-patent reference 3: Anal. Chem. 2006, 78, 827-834

### PROBLEMS TO BE SOLVED BY THE INVENTION

When biological tissue specimens are prepared for MALDI, biological components, such as lipids and sodium, inhibit the formation of homogeneous and fine co-crystals between matrices and protein and peptide specimens (Non-patent reference 1 etc.). Hence, the components are generally washed away by ethanol and the like, although it is impossible to remove the components completely. Therefore, it has been a problem that matrix crystals prepared on biological tissues are bigger in size than the crystals prepared on purified proteins and peptides, and they are not homogeneously distributed crystals.

Accordingly, previous method for adding matrices on biological tissue sections includes direct dispensation to the surface of tissues by a pipette, spray coating by an airbrush and printing very small amount of matrices by a chemical inkjet printer. However, dispensation by a pipette may accompany diffusion of matrix solution on the tissue surface, which may prevent from preparing crystals with good quality. Similarly, spraying enables to prepare very fine crystals, but has difficulty in coating the whole tissue surface with homogeneous density. On the other hand, chemical printer enables to prepare highly dense crystals on the whole tissue surface by setting suitable printing condition, but has difficulty in preparing crystals with good quality due to the same reason as dispensation method.

In consequence, the present invention provides a method for preparing a specimen, wherein the method comprises forming homogeneously microcrystals (i.e. co-crystals) with matrices on the specimen including biological molecules such as proteins and consequently forming ions highly efficiently measurable by MALDI based mass spectrometry with high sensitivity.

### MEANS TO SOLVE THE PROBLEMS

The method of the present invention comprises forming microcrystals on the specimen containing biological molecules, which is the object of the measurement, by spraying matrix solution beforehand. Furthermore, dispensation of matrix solution to the microcrystals by a means such as chemical inkjet printer and pipette results crystals to grow based on preformed micro-matrix crystals as crystal nuclei. Therefore, much finer and more homogeneous crystals (co-crystals) than those obtained before are prepared, wherein the former crystals enable highly sensitive mass spectrometry based on MALDI.

That is, the present invention is a method for preparing a specimen for mass spectrometry based on Matrix Assisted Laser Desorption Ionization method, comprising the steps of (a) spraying a matrix solution on a specimen containing biological molecules to form microcrystals of the matrix on the specimen and (b) dispensing a matrix solution on the specimen to grow the microcrystals on the specimen.

### ADVANTAGES OF THE INVENTION

The method of the present invention enables to prepare very fine and homogeneous crystals (co-crystals) on the specimen including biological molecules such as proteins as objects for measurement. Therefore, the sensitivity of the mass spectrometry based on MALDI by the use of thus prepared specimens is very high.

The previous method comprising dispersing microcrystals obtained beforehand by grinding matrices on the protein specimens and allowing matrices dispensed to grow to crystals (Non-patent reference 3) inevitably accompanies inhomogeneous microcrystals prepared at the former step and is unable to prepare fine and homogeneous crystals as obtained by the spray method of the present invention. Consequently, it is expected that the resultantly grown co-crystals are inevitably inhomogeneous and the sensitivity of the measurement in mass spectrometry of biological molecules is not high enough.

The method of the present invention resolved the previous problems by a very simple method and enabled to increase the sensitivity of the measurement in mass spectrometry of biological molecules.

### BRIEF DESCRIPTION OF THE DRAWINGS

FIG. 1 shows the outline of the steps for preparing the specimen of the present invention.

FIG. 2 shows an exemplified apparatus embodying the specimen preparation method of the present invention.

FIG. 3 shows photographs of microscopic observation of matrix crystals formed on a specimen: (a) shows the crystals of Example 1; (b) shows those of Comparative Example 1. The photographs show the observation after a single dispensation. Each of the circles (a) and (b) in FIG. 3 shows a trace of a single dispensation, wherein the diameter of the circle is about 1 mm.

FIG. 4 shows photographs of scanning electron microscope (SEM) observation of matrix crystals formed on a specimen.

FIG. 5 shows photographs of scanning electron microscope (SEM) observation of matrix crystals at a boundary region of a matrix solution dropping area.

FIG. 6 shows the mass spectra measured in Example 2: (a) and (b) show the mass spectrum of a specimen prepared in Example 1 and Comparative Example 1, respectively.

FIG. 7 show the photographs of microscopic observation of matrix crystals formed on a specimen: (a) and (b) show the photographs for Example 3 and Comparative Example 2, respectively. The photographs were taken after 30 times dispensation. Each of circles in the photographs is traces of 30 times dispensation and the diameters of the circles for (a) and (b) are about 300 μm and about 400 μm, respectively.

FIG. 8 shows the mass spectra measured for specimens prepared in Example 3 and Comparative Example 2: (a) and (b) show the photographs for Example 3 and Comparative Example 2, respectively.

FIG. 9 shows photographs of microscopic observation of matrix crystals of Example 4 and Comparative Example 3: (a) and (b) show the matrix crystals of Example 4 and Comparative Example 3, respectively.

FIG. 10 shows the mass spectra measured for specimens prepared in Example 4 and Comparative Example 3: (a) and (b) show the photographs for Example 4 and Comparative Example 3, respectively.

FIG. 11 shows the mass spectrum of m/z 798.5 peak of FIG. 10 (a) by tandem mass spectrometry.

FIG. 12 shows the mass spectra measured for specimens prepared in Example 5 and Comparative Example 4: (a) and (b) show the spectrum for Example 5 and Comparative Example 4, respectively.

FIG. 13 shows the comparison of peaks in mass spectra of FIG. 12 based on the relative intensity: (a) and (b) are the spectrum for Example 5 and Comparative Example 4, respectively.

FIG. 14 shows the mass spectrum of m/z 1544.8 peak of FIG. 12 (a) by tandem mass spectrometry.

### DETAILED DESCRIPTION OF THE INVENTION

The method of the present invention for preparing a specimen for mass spectrometry comprising (a) the first step of spraying a matrix solution on a specimen containing biological molecules to form microcrystals of the matrix on the specimen and (b) the second step of dispensing a matrix solution on the specimen to grow the microcrystals on the specimen.

The biological molecules as objects of the method of the present invention include proteins, peptides, lipids or glycolipids, or the mixture thereof. Specimens containing biological molecules include biological tissues and culture cells. The biological tissues include tissues of mammals such as human.

Usually, a specimen containing biological molecules is immobilized to a support. The support is generally a conductive support. Such conductive support includes a MALDI target plate, a conductive film (e.g. Indium-tin oxide-coated film (e.g. ITO film)), or metal-deposited glass (metals containing noble metals such as gold, platinum and the like).

Generally, biological tissues are prepared as follows before starting the application of the preparation method of the present invention. Less than 10 μm thick of frozen sections are prepared from biological tissues and are thawed on the above support. The frozen tissue sections are immobilized to the support as the result of thawing thereto. The immobilized tissues are washed by 70% ethanol and are dried.

Other specimens are preferably prepared according to the above procedures.

In the first step, matrices usable to the present invention include all types thereof generally used to MALDI, for example, 3,5-Dimethoxy-4-hydroxy-cinnamic acid (sinapic acid), α-Cyano-hydroxy-cinnamic acid (α-CHCA), 2,5-Dihydroxy benzoic acid (2,5-DHB), Isocarbostiril, 6-Aza-2-thiothymine, 1,8-Dihydroxy-9[10H]-anthracenone (Dithranol), 5-Chlorosalicylic acid (5-CSA), o-Nitrobenzoic acid, 3-Aminoquinoline, 2-Amino-3-hydroxypyridine, Esculetin, 2-(4-Hydroxy-phenylaza) benzoic acid (HABA), picolinic acid, anthranilic acid, nicotinic acid and the like.

Solvent for matrix solution used for spraying in the first stage includes simple organic solvent or a mixture of organic solvent with water, and a mixture of organic solvent with water is preferably used. Suitable organic solvent is solvent with high volatility, for example, solvent with a boiling point with equal to or less than 85° C., and more preferably boiling point between 55° C. and 85° C. at normal atmospheric pressure. Such organic solvent includes acetonitrile, methanol, ethanol, acetone, isopropanol and the like. The solvent suitable to 2,5-DHB includes 70% methanol (containing 0.1% TFA). The percentage of an organic solvent in the mixture of an organic solvent with water is preferably in the range between 50 and 90 volume %, and more preferably in the range between 40 and 60 volume %.

The solvent for spraying is ranging in concentration from 50 to 90 volume % and more preferably in concentration from 40 to 60 volume % of acetonitril (ACN) containing 0.1 volume % of trifluoroacetic acid (TFA) dissolved in water.

The above matrix is dissolved in the above solvent for the use of matrix solution for spray. The concentration of matrix solution is preferably in the range between 0.1 and 5.0 mg/mL and more preferably in the range between 1.0 and 3.0 mg/mL.

Spraying matrix solution is performed by a spray device. Examples of the spray device involve an air brush for manual training and a glass sprayer. As the condition of spray device, for example, the tip inner diameter of the nozzle is in the range between about 100 μm and 1 mm and preferably in the range between 100 μm and 300 μm; and the flow rate is in the range between about 10 μL/min and about 500 μL/min, and preferably in the range between 200 μL/min and 300 μL/min.

Once matrix solution is sprayed, matrix crystals are formed by evaporation of solvent during spraying or soon after arriving at the specimen, and microcrystals of matrices are scattered on the specimen. Spraying matrix solution may be repeated several times.

An example of the preferable spray method of matrix solution is shown as follows: for spraying, the spray device is fixed at an angle between 45° and 90° against a specimen surface, with the distance between the nozzle thereof and the tissue surface kept in the range between about 1 and 30 cm, and preferably in the range between about 10 and 25 cm. The specimen is sprayed with matrix solution during about 20 to 60 sec, and then is left standing during about 1 to 10 min. The procedure is repeated for about 3 to 10 times, and consequently microcrystals are formed on the tissue surface. The most preferable condition is the case, wherein the distance between the nozzle and the tissue surface is 15 cm, the angle is 45°, the spraying duration is 30 sec, the standing duration is 5 min and the repeat is 4 times.

Furthermore, it is preferable to spray in an environment with the humidity kept constant, since reproducibility of sensitivity of obtaining data is increased by the procedure. Water vapor pressure is preferably in the range between about 20 and 140 hPa. A preferable example is the condition, wherein wet clothes or paper towels are put into a tupper ware with volume of about 4000 cm³, and are kept warmed under saturated humidity in a thermostat bath at 37° C.

Homogeneous matrix crystals are generated uniformly on the tissue surface treated with spraying and the tissue surface shows an appearance with white turbidness by the formation of microcrystals. The specimen thus prepared are used for the next dispensation procedure. It may be possible to prepare and stock various and multiple specimens in the above step; and to continue the next dispensation procedure after taking out some specimens when the necessity arises.

In the second step, the matrices for dispensation can use the matrices shown above in the first step. Different matrices from that of the first step are also usable; in spite of this the same type of matrices is preferable.

The above solvent for spraying can be used for the solvent of matrix solution for dispensation in the second step, however the solvent with lower volatility than that for spraying is preferable. The solvent with low volatility includes, for example, a mixed solvent between water and organic solvent used for spraying with increased proportion of water.

The matrix solution for dispensation is adjusted to the concentration between 5.0 mg/mL and saturated concentration (about 30 mg/mL for 50% ACN). The suitable concentration is 8.0 mg/mL. Since the matrix solvent for dispensation has preferably low volatility, ACN containing 0.1% TFA is adjusted to the range between 25 and 60 volume %, and preferably between 40 and 50 volume %.

The procedures in the second step are preferably performed in a humid environment as performed in the first step. The feature of the present procedures are as follows: fine liquid drops of matrix solution are formed on tissue surfaces under the environment with the humidity kept constant, and repeated formation of liquid drops and evaporation result in increased amount of extraction of proteins from the tissue specimen. Also, according to the experimental evidence, it is impossible that stable crystal nuclei are formed on the tissue specimen under the condition of low humidity. The evidence is interpreted as that crystallization starts in air under a low humidity condition and the microcrystals are too stable to act as crystal nuclei on the tissue specimen. It is presumed that the microcrystals are changed to amorphous in contact with water on the tissue surface.

Dispensation may be performed by a standard dispensation method, for example, by a pipette or an automatic reagent dispenser. Dispensation may be repeated for several times. Fine and homogeneous matrix crystals can be obtained by repeating small amount of dispensation in the range between 0.5 and 5 nL, and preferably 0.5 and 1.5 nL, until intended amount, in the case of dispensation by the use of automatic reagent dispenser. Suitable condition is to repeat 1 nL dispensation for 50 times after spraying and to dispense total 50 nL of matrix solution to nano-domain of a tissue surface. It is desirable that the dispensation sites are complete or half dried state at the end of a single dispensation procedure. The time span necessary to keep the complete or half dried state depends on the number of the print sites and is preferably 30 sec standing between the last printing and the next one for less than 10 print sites. For more than 10 print sites, it is preferable to have about 1 min standing before starting next print.

Drying step may be inserted after dispensation. However, solvent might be evaporated spontaneously by standing the specimen for a certain time period without the use of drying step. For drying step, a simple blower (e.g. Japanese Patent Publication, 2003-98154 and the like), or a warm air blower may be used.

Each of repeated dispensation steps for several times may accompany the above drying step.

It is preferable that the specimen is dried (i.e. the solvent is evaporated) before the next step (i.e. mass spectrometry).

After dispensation of matrix solution, the specimen is introduced into MALDI-type mass spectrometer for analysis.

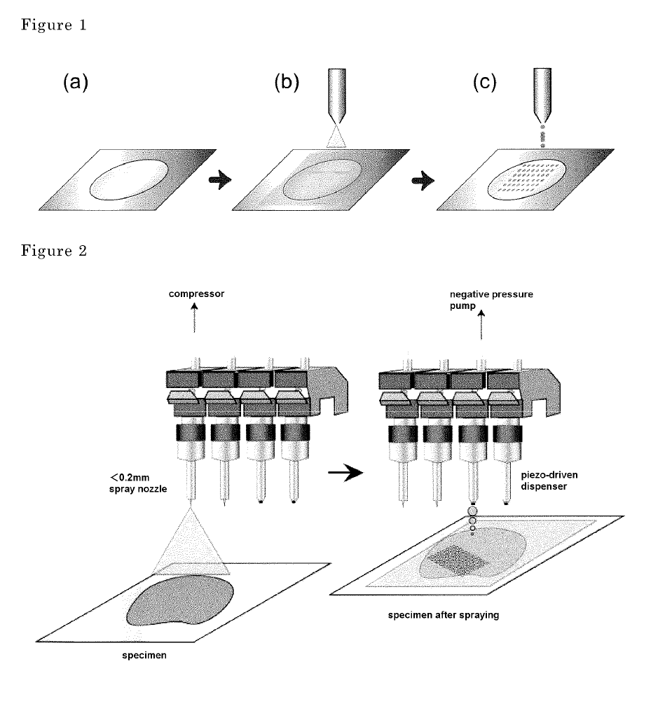

The above procedures are shown in FIG. 1. Step (a) is placing a tissue section immobilized on a conductive material. Step (b) is spraying a matrix solution with low concentration of matrix on a tissue surface. Step (c) is dispensing a matrix on the tissue surface by pipette or automatic reagent dispenser after formation of microcrystals by spraying.

The apparatus embodying the method for preparing a specimen is exemplified to FIG. 2. The specimen preparation apparatus for mass spectrometry comprises (a) a conductive support to immobilize the specimen containing biological molecules, (b) a spray device for spraying a matrix solution on the specimen that is immobilized on the conductive support, and (c) a dispenser to dispense a matrix solution on the specimen. The spray device and the dispenser may be separated as a specimen preparation apparatus for mass spectrometry. Namely, the specimen preparation apparatus for mass spectrometry may be composed of two parts, i.e. one is spray part and the other is dispensation part. The apparatus may have the configuration, wherein the spray part is used to spray matrix solution on the specimen, and the specimen and the support thereof are moved to dispensation part, where dispensation is carried out.

Furthermore, the apparatus needs to be equipped with (d) a control device for moving (i) the support, or (ii) the spray device and the dispenser, to dispense a matrix solution on the sprayed area of the specimen after the matrix solution is sprayed on the specimen by the spray device. Additionally, the apparatus may be equipped with (e) a reservoir and a feed pump for supplying matrix solution to the spray device and the dispenser; (I) humidity controlling apparatus to keep the atmosphere of specimens at constant humidity; and (g) a drying device (e.g. a blower) to enhance evaporation of the solvent on the specimen after dispensation. The above control device may control the transport of dispenser to dispense matrix solution to the microcrystals by recognizing the sites of matrix microcrystals formed on specimens after spraying. Moreover, the control device for transport may control the dispensation to multiple sites on a specimen, or to the same site repeatedly for multiple dispensations.

Also, the specimen preparation apparatus for mass spectrometry may be combined together with MALDI apparatus to the mass spectrometric apparatus to form a set of mass spectrometric apparatus.

### EXAMPLES

The following Examples illustrate the present invention but it is not intended to limit the scope of the present invention.

### Example 1

In this Example, the crystalline state inside a matrix spot was observed by a scanning electron microscope (SEM).

Firstly, a mouse brain frozen section prepared at 5 μm thick was thawed on an ITO-deposited slide glass (Bruker Daltonics) to be immobilized. The immobilized section was washed two times with 70% ethanol for 30 sec and dried in a vacuum desiccator for 10 min to form a section specimen.

Then, matrix solution for spraying was prepared by dissolving sinapic acid (Bruker Daltonics, Matrix substance for MALDI-MS) at a concentration of 2.0 mg/mL (solvent: 50% ACN/0.1% TFA) in a solvent, wherein both 0.1 volume % TFA (Kanto Chemical Co. Inc., Saitama, Japan; sequence grade) and 50 volume % ACN (Kanto Chemical Co. Inc., Saitama, Japan; sequence grade) were dissolved in water (the solvent is referred to as [50% ACN/0.1% TFA]).

Matrix solution was sprayed on the section specimen by air brush (GSI Creos, Tokyo, Japan; PROCON BOY FWA platinum 0.2 double action). The spraying was performed with the distance between the specimen surface and spray nozzle of the air brush kept at about 15 cm and with the angle between the specimen surface and the spray nozzle fixed at 45°. Spray duration was 30 sec and the specimen was kept standing for 5 min after spraying. The procedures were repeated four times and the total volume for coating was about 500 μL.

All the spraying procedures were performed in a humidified box, wherein wet cloths or paper towels for experiment were put into a tupper ware with a volume of about 4000 cm³, and are kept warmed under saturated humidity in a thermostat bath at 37° C.

The specimens were dried after the end of spraying. As the result, microcrystals were formed on the tissue surface. The sizes of the crystals were about 2 μm.

Then, sinapic acid solution (8.0 mg/mL; solvent: 50% ACN/0.1% TFA) was prepared as matrix solution for dispensation.

The specimen were dispensed 0.1 μL of matrix solution by hand by the use of a pipette and were dried for 10 min in a vacuum desiccator.

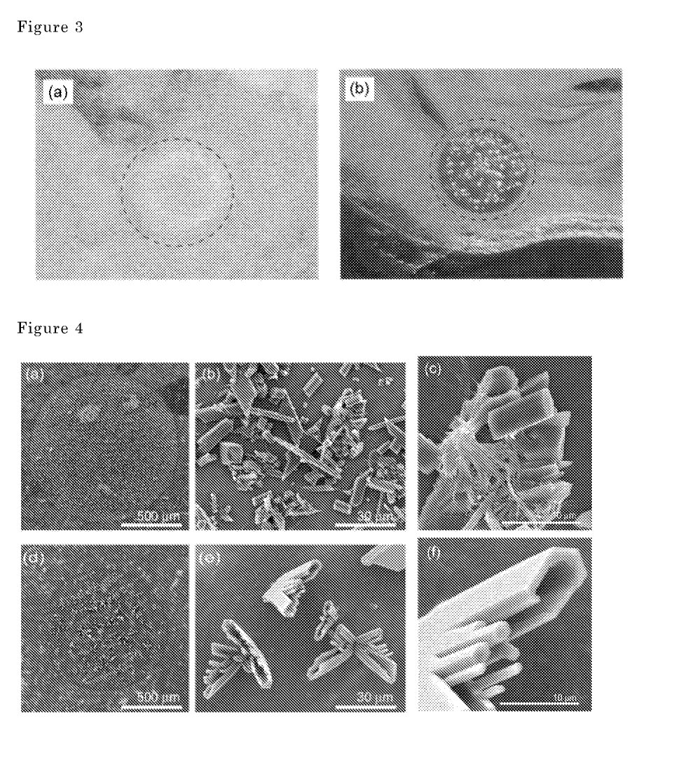

FIG. 3 shows a photograph of a stereo microscope for crystal topography of the present Example and of the following Comparative Example 1. The size per a crystal obtained in the present Example was about 10 μm (FIG. 3(a)) and that in the following Comparative Example 1 was about 50 μm (FIG. 3 (b)). It is shown that the crystals of the former are finer and denser than that of the latter.

### Comparative Example 1

Similar to Example 1, a mouse brain frozen section prepared at 5 μm thick was thawed on an ITO slide glass (Bruker Daltonics) to be immobilized. The immobilized section was washed for two times with 70% ethanol for 30 sec and was dried in a vacuum desiccator for 10 min to form a section specimen.

The section specimen was directly dispensed 0.1 μL of sinapic acid solution (concentration: 8 mg/mL, solvent: 50% ACN/0.1% TFA) by hand pipetting and was dried for 10 min in a vacuum desiccator.

### Crystal Observation by Scanning Electron Microscope (SEM)

The mouse brain tissue surface obtained in Example 1 and Comparative Example 1 was coated with platinum-palladium complex (Nilaco Co., Pt:Pd=80:20) by the use of a magnetron ion sputter coater (Hitachi, Tokyo, Japan; E1030) and was observed by a field emission type scanning electron microscope (Hitachi, S-4500). The observation was performed under the observation condition with lower detection mode, wherein secondary electron generated directly under the platinum-palladium membrane are detectable. SEM photographing was performed one day after dispensation.

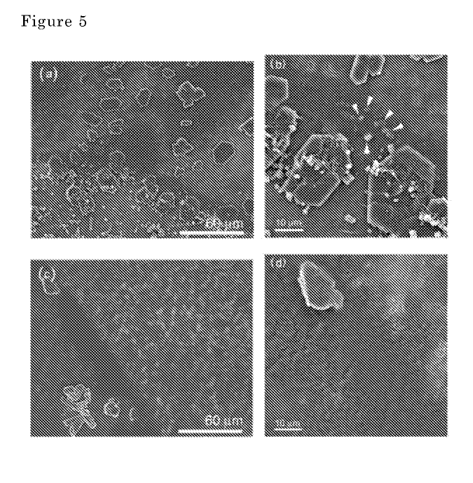

FIGS. 4 (a), (b), and (c); and FIGS. 5 (a) and (b) show the SEM photographs of crystals obtained in Example 1, and FIGS. 4(d), (e) and (f); and FIGS. 5 (c) and (d) show the SEM photographs of crystals obtained in Comparative Example 1.

Comparison of FIG. 4 (a) with FIG. 4 (d) shows that the crystal density of Comparative Example 1 is higher than that of Example 1. Furthermore, comparison of FIG. 4 (b) with FIG. 4 (e), wherein FIGS. 4 (b) and (e) are enlarged photographs of FIGS. 4 (a) and (d), respectively, shows that not only density but also the crystalline state of each crystals is much different among the above figures. Crystals of Comparative Example 1 grew cluster like and their sizes are equal to or more than 30 μm and insides of crystals are cavitated. On the contrary, it is shown that crystals of Example 1 are formed independently as the crystals with size between about 10 μm and 20 μm, which are connected with filamentous crystals with about 500 nm thick.

FIG. 5 shows the photograph of scanning electron microscopic observation of matrix crystals at a boundary region of a matrix solution dropping area. FIGS. 5 (b) and 5 (d) are enlarged photographs of those in FIGS. 5 (a) and 5 (c), respectively.

As shown by a white arrowhead in FIG. 5 (b), it is possible to confirm that matrix crystals are on the process of growing as if they are protruded from the interior of tissue section to the surface thereof at a boundary region in Example 1. Evidently, crystals are allowed to grow by dropping solution from the crystal nuclei (the size is about 2 μm) formed inside the tissue section by the invasion of spraying matrix solution. Moreover, as shown in FIG. 5 (a), there are sprayed crystals with relatively large size outside the dropping region, but fine crystal nuclei with size comparable to the microcrystals formed inside the boundary region were not confirmed. Based on the above results, it is possible to suggest that invaded crystal nuclei are formed inside the tissue section and crystals are growing from the nuclei, although the nuclei formation is not confirmed from the surface observation.

Contrary to this, as shown in FIGS. 5 (c) and (d), there were no such crystal nuclei obtained in Comparative Example 1.

From the above evidence, it can be proposed that not only fine matrix crystals but also matrix crystals grown from the crystal nuclei inside the tissue and filamentous crystals obtained in Example 1 contribute to improve the sensitivity and S/N ratio in MS measurement.

### Example 2

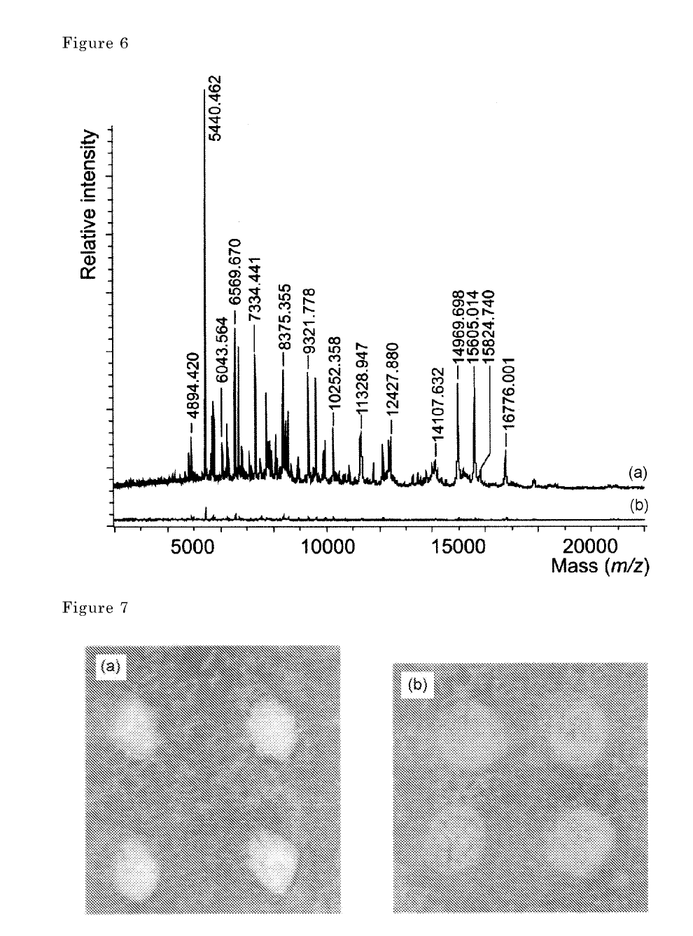

Mass spectrometry was performed for specimens prepared in Example 1 and Comparable Example 1 by the use of MALDI-TOF type Ultraflex II TOF/TOF (Bruker Daltonics). The measurement was by positive ion-detection mode and the detection mass range was between m/z 4000 and m/z 20000. FIG. 6 shows the mass spectra.

As shown in FIG. 3, crystals of Example 1 (FIG. 3 (a)) are finer and denser than those of Comparative Example 1 (FIG. 3 (b)). While, for mass spectra, the peak intensity and S/N ratio in the mass spectrum of the specimen of Example 1(spectrum (a) in FIG. 6) increased 32.3 fold in average and 9.9 fold, respectively, compared to those of Comparative Example 1 (spectrum (b) in FIG. 6). The numbers of detectable signal peaks were 290 and 200 signals for (a) and (b) in FIG. 6, respectively.

### Example 3

In this Example, mass spectrometry was performed for specimens of digested biological tissues prepared according to the method of the present invention.

Mouse brain tissues prepared at 5 μm thick and mounted on a gold-coated glass were washed two times with 70% ethanol for 30 sec and dried. The tissue specimens were sprayed with a denaturant comprising 10% SDS, 25 mM, DTT, 70% ethanol, and 0.5 M Tris/HCl (pH 6.8) by an air brush, and kept standing for 12 hr under the atmosphere of saturated denaturant at 80° C. After denaturation, the specimen were washed with 70% ethanol for 30 sec, and dried in a vacuum desiccator for 10 min. After dryness, the specimen were sprayed with a reagent solution, wherein trypsin, a digestion enzyme, was dissolved at a concentration of 200 mg/mL in a solvent containing 25 mM ammonium bicarbonate and 10% isopropanol. At the time of spraying, the distance between the spray nozzle and the specimen surface was kept at 15 cm allowing the digestion solution to cover the whole tissue, and spraying was performed once for 30 sec. After spraying, the specimen were kept in an incubator at 37° C. for 12 hr.

α-CHCA (Bruker Daltonics, Matrix substance for MALDI-MS) solution was prepared at the concentration of 2.0 mg/mL (50% ACN/0.1% TFA) as matrix solution for spraying. After digestion and dryness, the specimen were sprayed with the matrix solution according to the same method in Example 1.

On the other hand, α-CHCA solution was prepared at the concentration of 8.0 mg/mL (50% ACN/0.1% TFA) as matrix solution for dispensation. Matrix solution was dispensed by chemical inkjet printer (Shimadzu Corp. Kyoto, Japan; CHIP-1000). According to the dispensation condition, the volume of a single dispensation was 1 nL and total volume of dispensation per one spot was 30 nL of α-CHCA by the repeat of the dispensation for 30 times. Time interval between a printing and the next was 30 sec. FIG. 7 (a) shows the photograph of the crystals obtained. The size of a single crystal obtained was about 5 μm (FIG. 7(a)). That obtained in the following Comparative Example 2 was about 25 μm (FIG. 7 (b)). The crystals obtained in the present Example were finer and denser than those obtained in the following Comparative Example 2. More specifically, cracks like crazing are observed at some dispensation spots for those (FIG. 7 (b)) obtained by matrix dispensation without matrix spraying. Additionally, since dispensation solution is apt to diffuse on the tissue surface, the color of matrices at dispensation sites is faint after solvent evaporation and crystal formation. The faint color of matrices implies sparse crystal formation in FIG. 7 (b). Contrary to this, cracks were not observed at the dispensation spots after crystal formation and the color of the dispensation spots are deeper than those in FIG. 7 (a), since diffusion of dispensation solution is smaller than those in conventional methods.

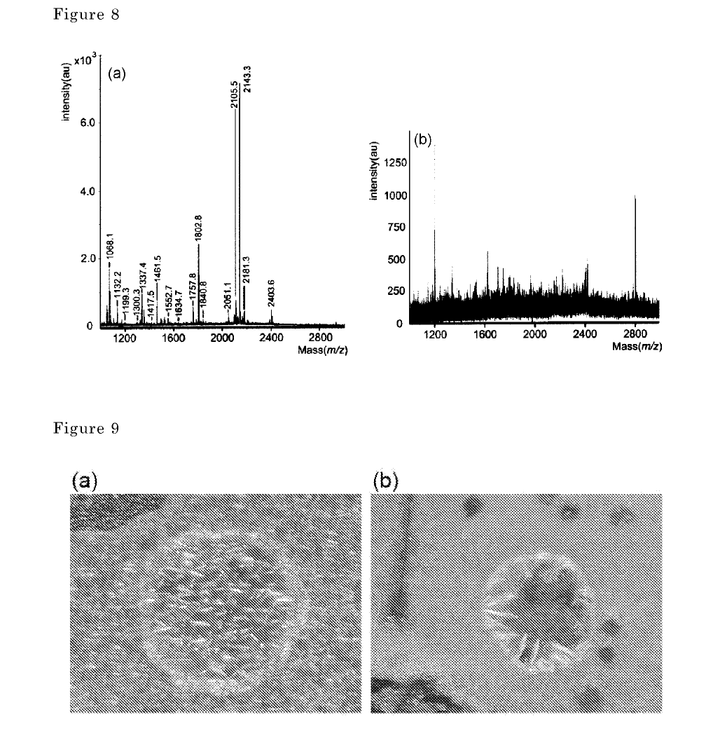

The specimens thus prepared were subjected to mass spectrometry by MALDI-TOF type UltraflexII TOF/TOF (Bruker Daltonics). The measurement was by a positive ion-detection mode and the detection mass range was between m/z 1000 and m/z 3000. FIG. 8 (a) shows the mass spectrum obtained. The peak signal intensity of the present Example increased ten fold in average compared to that for crystals in the following Comparative Example 2 (FIG. 8 (b))

### Comparative Example 2

After mouse brain tissue specimens digested in Example 3 were dried, the brain tissues were directly dispensed by chemical inkjet printer (CHIP-1000). The matrix solution and the condition of dispensation are similar to those in Example 3. FIG. 7 (b) shows a photograph of crystals obtained in Comparative Example 2.

The specimens thus prepared were subjected to mass spectrometry by MALDI-TOF type UltraflexII TOF/TOF (Bruker Daltonics). The measurement was by a positive ion-detection mode and the detection mass range was between m/z 1000 and m/z 3000. FIG. 8 (b) shows the mass spectrum obtained.

### Example 4

In this Example, lipids are measured.

Rat cerebellum sections formed at 5 μm thick on ITO films were dried without washing. Furthermore, matrix solution for spraying was prepared by dissolving 2,5-DHB in a solvent containing 70% methanol/0.1% TFA at a concentration of 8.0 mg/mL. Similarly to the method in Example 1, the specimen were sprayed with the matrix solution for spraying.

Moreover, matrix solution for dispensation was prepared by dissolving 2,5-DHB at a concentration of 10.0 mg/mL in 50% methanol/0.1% TFA.

The specimens were dispensed 0.1 μL of matrix solution by hand pipetting and were dried for 10 min in a vacuum desiccator. FIG. 9 shows the microscopic photograph of the specimen: (a) is matrix crystals of the present invention; (b) is those of the following Comparative Example 4.

FIG. 9 (a) shows the formation of crystals of 2,5-DHB in the whole area of dispensation sites, while FIG. 9 (b) shows complete failure in formation of 2,5-DHB crystals at the center of the dispensation sites. Since lipids inhibit the formation of matrix crystals as described above, FIG. 9 (b) is exerted significantly the effect of lipids.

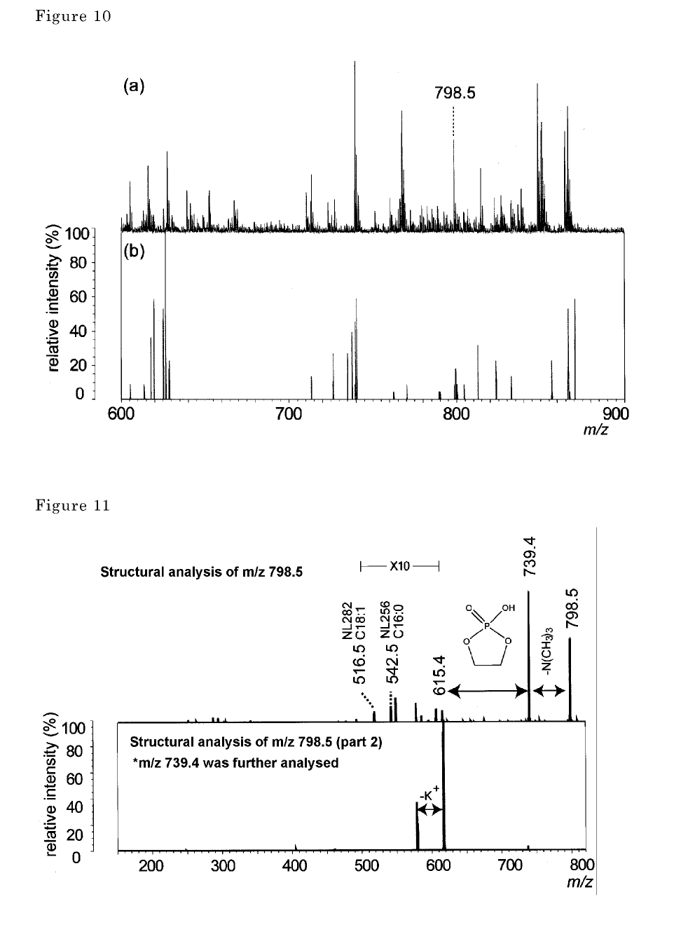

The specimen were subjected to mass spectrometry by the use of MALDI-QIT-TOF type tandem mass spectrometer AXIMA-QIT (Shimadzu) equipped with Quadrupole ion trap (QIT). The measurement was by a positive ion-detection mode and the detection mass range was between m/z 600 and m/z 900. FIG. 10 shows the mass spectra: (a) is the spectrum from the present Example; (b) is that from Comparative Example 3. Evidently, numbers of signal peaks obtained are predominantly more in the present Example (FIG. 10 (a)) than that in Comparative Example 3.

Then, structural analysis of the previous peak with m/z 798.5 was performed. Namely, ions with m/z 798.5 were trapped inside QIT by the application of appropriate AC voltage on QIT by the use of AXIMA-QIT. After the trap thereof, argon gas was introduced inside QIT via a bulb equipped to QIT. Argon gas enclosed inside QIT collides with trapped ions to dissociate ions. The mass of the ions dissociated by the collision with argon gas was measured by TOF equipped to the latter part of QIT. FIG. 11 shows the result.

Mass spectrometry of dissociated state gives mass spectrum reflecting the structure of the parent ion. The measurement showed that m/z 798.5 was an ion representing a kind of glycerophospholipid referred to as phosphatidylcholine (C16:0-C18:1) added with potassium derived from a living organism. As shown the structure in the following schema [Chemical Formula 1], the lipid has the structure, wherein a palmitic acid and an oleic acid are bound to carbons at 1-position and 2-position, respectively, of glycerol and a phosphocholine bounds to carbon at 3-position.

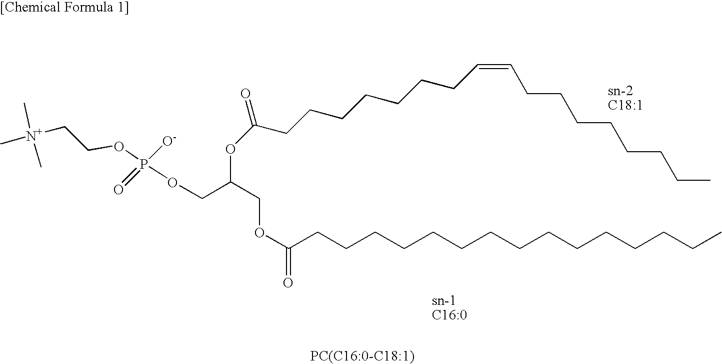

The result shows that the method of the present invention is useful also to the detection of lipids.

### Comparative Example 3

Rat cerebellum sections formed at 5 μm thick on ITO films were dried without washing.

The specimen were dispensed directly 0.1 mL of 2,5-DHB (concentration: 10.0 mg/mL, solvent: 50% methanol/0.1% TFA) by hand pipetting and were dried in a vacuum desiccator. The specimen was subjected to mass spectrometry similarly to Example 4. FIG. 10 (b) shows the result.

### Example 5

In the present Example, glycolipids were measured. Rat cerebrum sections formed at 5 μm thick on ITO films were dried without washing. Section specimens similarly to Example 4 were prepared by the treatment of the cerebrum sections with both matrix solutions for spraying and for dispensation similar to Example 4.

Then, the section specimens were subjected to mass spectrometry by the use of MALDI-QIT-TOF type AXIMA-QIT (Shimadzu).

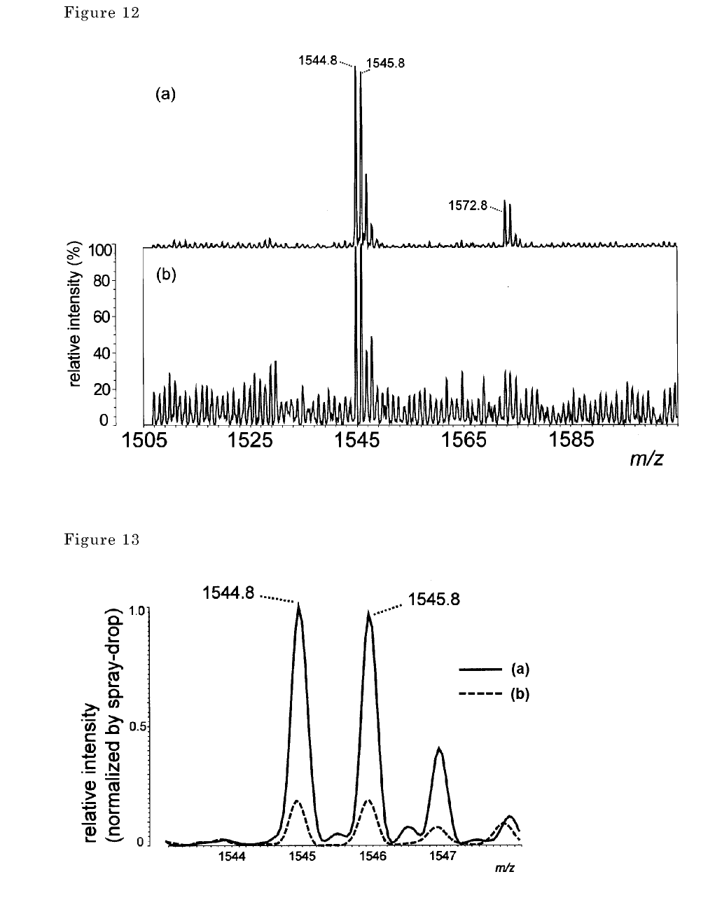

The measurement was by a negative ion-detection mode and the detection mass range was between m/z 1000 and m/z 2000. FIG. 12 shows the mass spectra: (a) shows the mass spectrum by the present invention; (b) shows the mass spectrum of a specimen by Comparative Example 4.

Additionally, FIG. 12 shows that m/z 1544.8 peak was observed for both specimens (m/z 1545.8 is a peak by an isotope). Evidently, the base line of the spectrum obtained by the present invention is very low in case compared the base lines of both spectra. The result is due to that the peak intensity of the present Example is stronger than that by Comparative Example 4.

FIG. 13 shows relative peak intensity of the actual spectra compared between Example 5 and Comparative Example 4: a solid line shows the result of Example 5; a dotted line shows the result of Comparative Example 4. It is interpreted that the peak intensity was improved about 5 folds. Moreover, another peak at m/z 1572.8 is observed in FIG. 12 (a), while the corresponding peak was not observed in FIG. 12 (b).

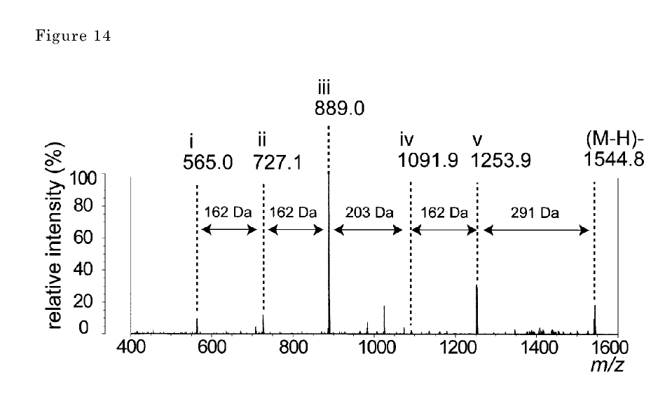

The peak m/z 1544.8 was subjected to structural analysis by tandem mass spectrometry similarly to Example 4 and the result is shown in FIG. 14.

The analysis of spectrum obtained shows that the structure contains three hexoses (derived from 162 Da spacing), one N-acetylhexosamine (derived from 203 Da spacing) and one sialic acid (derived from 291 Da spacing). These are sugar chains and a peak derived from ceramide is also detected at m/z 565.0. Therefore, m/z 1544.8 is derived from a glycolipid. Since it contains sialic acid, the glycolipid is called specifically ganglioside.

The proposed structures of the gangliosides are shown in Chemical Formula 2 below. The structures corresponding to the peaks of the spectrum are shown by Greek digits. Two kinds of gangliosides, GM1a and GM1b, depend on the binding sites of sialic acid.

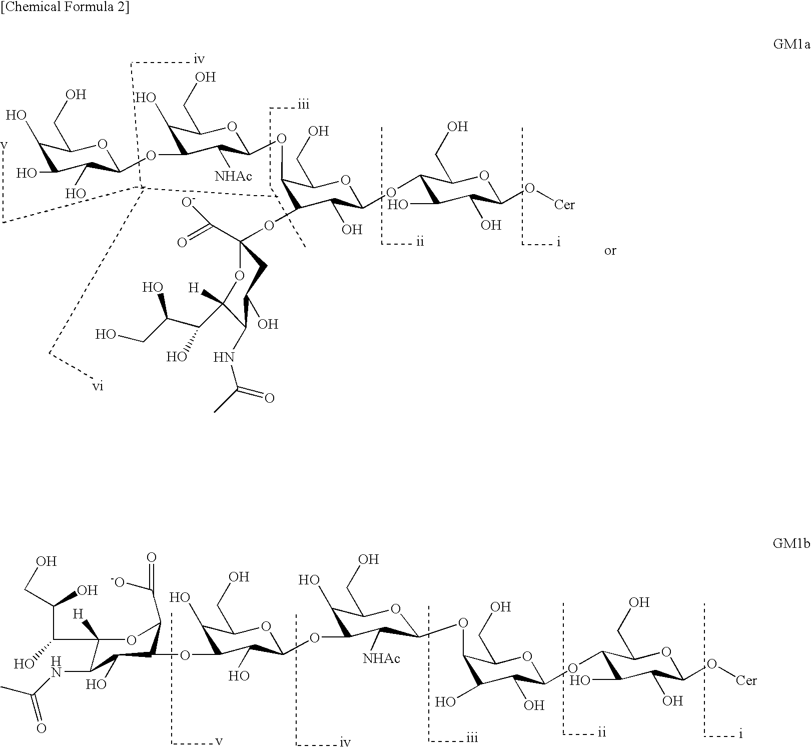

The results show that the method of the present invention is useful to the detection of glycolipids.

### Comparative Example 4

Rat cerebrum sections formed at 5 μm thick on ITO films were prepared similarly to Comparative Example 3 by drying without washing for comparison.

1. A method for preparing a specimen for mass spectrometry based on the Matrix Assisted Laser Desorption Ionization method, comprising the steps of (a) spraying a matrix solution on a specimen containing biological molecules to form microcrystals of the matrix on the specimen and (b) dispensing a matrix solution on the specimen to grow the microcrystals on the specimen.

2. The method of claim 1 further comprising (c) drying the specimen.

3. The method of claim 2, wherein the steps of (b) dispensing a matrix solution to the specimen and (c) arbitrarily drying the specimen are repeated multiple times.

4. The method of claim 1 wherein the specimen is immobilized on a conductive support.

5. The method of claim 1 wherein the specimen is a biological tissue.

6. The method of claim 1, wherein the specimen is digested beforehand.

7. A specimen for mass spectrometry, which is prepared by the method of claim 1.

8. A method for analyzing a biological tissue comprising the steps of (a) ionizing the specimen prepared by the method of claim 1 according to Matrix Assisted Laser Desorption Ionization method and (b) subjecting the specimen to mass spectrometry.

9. A specimen containing biological molecules for mass spectrometry based on Matrix Assisted Laser Desorption Ionization method, prepared by spraying a matrix solution on a specimen to form microcrystals on the specimen.

10. The specimen of claim 9, wherein the specimen is immobilized on a conductive support.

11. The specimen of claim 10, wherein the specimen is a biological tissue.

12. An apparatus for preparing a specimen containing biological molecules for mass spectrometry based on Matrix Assisted Laser Desorption Ionization method, comprising (a) a conductive support to immobilize the specimen, (b) a spray device for spraying a matrix solution on the specimen that is immobilized on the conductive support, (c) a dispenser to dispense a matrix solution on the specimen, and (d) a control device for moving (i) the support, or (ii) the spray device and the dispenser, to dispense a matrix solution on the sprayed area of the specimen after the matrix solution is sprayed on the specimen by the spray device.
